(19) United States
(12) Patent Application Publication
(10) Pub. No.: US 2025/0139826 A1
(43) Pub. Date: May 1, 2025

(54) SELF-POSITION ESTIMATION SYSTEM, SELF-POSITION ESTIMATION APPARATUS, AND SELF-POSITION ESTIMATION METHOD

(71) Applicant: NEC Corporation, Tokyo (JP)

(72) Inventor: Hidemi NOGUCHI, Tokyo (JP)

(73) Assignee: NEC Corporation, Tokyo (JP)

(21) Appl. No.: 18/910,028

(22) Filed: Oct. 9, 2024

(30) Foreign Application Priority Data
Oct. 30, 2023 (JP) 2023-185668

(51) Int. Cl. G06T 7/73; G06T 7/33

(52) U.S. Cl. CPC G06T 7/75; G06T 7/344; G06T 2207/10028; G06T 2207/30252

(57) ABSTRACT

Provided is a self-position estimation system including: a reference environment point cloud storage means for storing a reference environment point cloud for self-position estimation; a point cloud acquisition means for acquiring a short-distance point cloud in a wide field of view, and a long-distance point cloud farther away than the short-distance point cloud and in a narrow field of view; a rough estimation means for performing rough estimation on a self-position by registering the short-distance point cloud with respect to the reference environment point cloud; and a precision estimation means for performing precision estimation on the self-position by registering the long-distance point cloud with respect to the reference environment point cloud by using, as an initial condition, a rough estimation result by the rough estimation means.

### INCORPORATION BY REFERENCE

This application is based upon and claims the benefit of priority from Japanese patent application No. 2023-185668, filed on Oct. 30, 2023, the disclosure of which is incorporated herein in its entirety by reference.

### TECHNICAL FIELD

The present disclosure relates to a self-position estimation system, a self-position estimation apparatus, and a self-position estimation method.

### BACKGROUND ART

Japanese Unexamined Patent Application Publication No. 2018-049014 discloses an autonomous traveling vehicle including a sensor unit including first light detection and ranging (LiDAR) and second LiDAR. Specifically, the first LiDAR is used for detecting an object at a distance of about 100 meters from the vehicle. The first LiDAR is configured to measure a distance in a field of view (FoV) having a horizontal angle of 360 degrees and a vertical angle of 20 degrees. Meanwhile, the second LiDAR is used for detecting an object at a distance of about 300 meters from the vehicle. The second LiDAR is configured to measure a distance in a FoV having a horizontal angle of 8 degrees and a vertical angle of 15 degrees. The vehicle autonomously travels based on a point cloud being output from the first LiDAR and a point cloud being output from the second LiDAR.

### SUMMARY

In a field of an automatic driving technique of an automobile, simultaneous localization and mapping (SLAM) using a LiDAR point cloud is proceeding toward practical utilization. Similarly, in a field of a railway, practical utilization of automatic driving using the SLAM is also expected.

For example, in order to achieve automatic driving of a train that travels at a speed equal to or more than 100 kilometers an hour, an area ahead at a distance equal to or more than 500 meters from the train typically needs to be monitored in consideration of a braking distance in which an obstacle in the area ahead can be detected and the train can be safely stopped. In order to monitor a distant place in such a manner, a three-dimensional map of an environment in an area ahead in a heading direction of a train is required to be highly accurately reconstructed to a distant place by using the SLAM described above.

In order to highly accurately reconstruct a three-dimensional map by using the SLAM, highly accurately performing position correction on a LiDAR point cloud acquired from a LiDAR apparatus mounted on a train, in response to a movement of the train, is indispensable. The reason is that the three-dimensional map is reconstructed by overlapping, again and again, LiDAR point clouds subjected to appropriate position correction. Further, to begin with, the reason is that a coordinate value of a LiDAR point cloud being output from the LiDAR apparatus is naturally expressed in a LiDAR coordinate system fixed in the LiDAR apparatus instead of a map coordinate system of the three-dimensional map. Then, in order to achieve the highly accurate position correction described above, a position of the LiDAR coordinate system in the map coordinate system of the three-dimensional map needs to be highly accurately estimated in the first place. Herein, estimating a position of the LiDAR coordinate system is generally referred to as self-position estimation. Further, a position of the LiDAR coordinate system in the map coordinate system of the three-dimensional map is formed of a three-axis translational component and a three-axis rotational component.

However, in terms of a characteristic of the LiDAR apparatus, a point cloud density of a LiDAR point cloud at a distant place from the LiDAR apparatus is relatively low. Therefore, it is considerably difficult to highly accurately estimate a self-position by using a LiDAR point cloud at a distant place from the LiDAR apparatus.

In contrast, it is considered to increase a point cloud density of a LiDAR point cloud at a distant place from the LiDAR apparatus by narrowing an FoV of the LiDAR apparatus. However, in this case, a LiDAR point cloud becomes an extremely small cluster, and thus registration computation for registering a LiDAR point cloud with respect to a reference point cloud may converge into a wrong solution, and highly accurate self-position estimation may be difficult similarly to the description above.

As described above, it is not easy to highly accurately reconstruct, to a distant place, a three-dimensional map of an environment in an area ahead in a heading direction of a train by using the SLAM. Therefore, an area ahead in a heading direction of a train to a distant place cannot be sufficiently monitored.

Thus, an example object of the present disclosure is to provide a highly accurate self-position estimation technique using a long-distance point cloud.

In a first example aspect, a self-position estimation system includes:
a reference environment point cloud storage means for storing a reference environment point cloud for self-position estimation;
a point cloud acquisition means for acquiring a short-distance point cloud in a wide field of view, and a long-distance point cloud farther away than the short-distance point cloud and in a narrow field of view;
a rough estimation means for performing rough estimation on a self-position by registering the short-distance point cloud with respect to the reference environment point cloud; and
a precision estimation means for performing precision estimation on the self-position by registering the long-distance point cloud with respect to the reference environment point cloud by using, as an initial condition, a rough estimation result by the rough estimation means.

In a second example aspect, a self-position estimation apparatus includes:
a reference environment point cloud storage means for storing a reference environment point cloud for self-position estimation;
a point cloud acquisition means for acquiring a short-distance point cloud in a wide field of view, and a long-distance point cloud farther away than the short-distance point cloud and in a narrow field of view;
a rough estimation means for performing rough estimation on a self-position by registering the short-distance point cloud with respect to the reference environment point cloud; and
a precision estimation means for performing precision estimation on the self-position by registering the long-distance point cloud with respect to the reference environment point cloud by using, as an initial condition, a rough estimation result by the rough estimation means.

In a third example aspect, a self-position estimation method includes:
storing a reference environment point cloud for self-position estimation;
acquiring a short-distance point cloud in a wide field of view, and a long-distance point cloud farther away than the short-distance point cloud and in a narrow field of view;
performing rough estimation on a self-position by registering the short-distance point cloud with respect to the reference environment point cloud; and
performing precision estimation on the self-position by registering the long-distance point cloud with respect to the reference environment point cloud by using, as an initial condition, a rough estimation result of the rough estimation.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram of a self-position estimation system;

FIG. 2 is a block diagram of a train;

FIG. 3 is a plan distribution map of distance measuring points;

FIG. 4 is an explanatory diagram of a distance measuring field of view;

FIG. 5 is a control flow of an environment point cloud generation apparatus;

FIG. 6 is a block diagram of a train;

FIG. 7 is a plan distribution map of distance measuring points;

FIG. 8 is an explanatory diagram related to continuity of a point cloud;

FIG. 9 is a block diagram of a train;

FIG. 10 is a data structure diagram of a building position database;

FIG. 11 is a plan distribution map of distance measuring points;

FIG. 12 is a diagram illustrating a relationship between a long-distance point cloud and a contributory point cloud;

FIG. 13 is a block diagram of the environment point cloud generation apparatus;

FIG. 14 is a diagram illustrating a relationship between a reference environment point cloud and a partial reference environment point cloud;

FIG. 15 is a diagram illustrating a case where a processing circuit included in the environment point cloud generation apparatus is constituted of a processor and a memory; and

FIG. 16 is a diagram illustrating a case where the processing circuit included in the environment point cloud generation apparatus is constituted of dedicated hardware.

### EXAMPLE EMBODIMENT

### (Outline of the Present Disclosure)

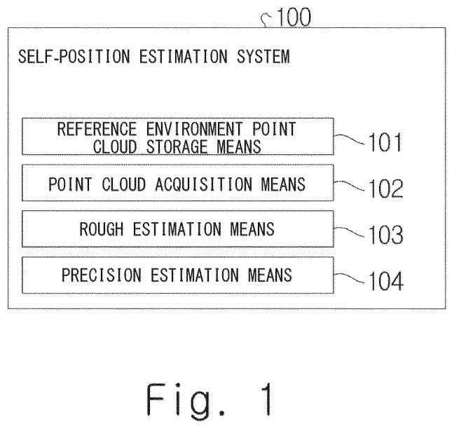

An outline of the present disclosure is as follows. FIG. 1 is a block diagram of a self-position estimation system.

As illustrated in FIG. 1, a self-position estimation system 100 includes a reference environment point cloud storage means 101, a point cloud acquisition means 102, a rough estimation means 103, and a precision estimation means 104.

The reference environment point cloud storage means 101 stores a reference environment point cloud for self-position estimation.

The point cloud acquisition means 102 acquires a short-distance point cloud in a wide field of view, and a long-distance point cloud farther away than the short-distance point cloud and in a narrow field of view.

The rough estimation means 103 performs rough estimation on a self-position by registering the short-distance point cloud with respect to the reference environment point cloud.

The precision estimation means 104 performs precision estimation on the self-position by registering the long-distance point cloud with respect to the reference environment point cloud by using, as an initial condition, a rough estimation result by the rough estimation means 103.

With the configuration described above, a highly accurate self-position estimation technique using a long-distance point cloud is achieved.

### First Example Embodiment

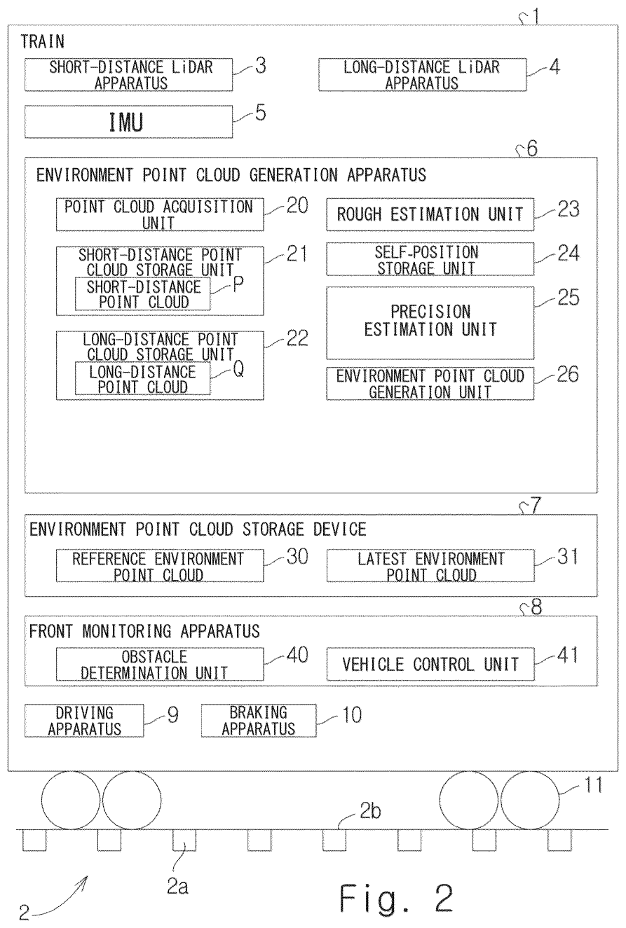

Next, a first example embodiment of the present disclosure will be described. FIG. 2 is a block diagram of a train. As illustrated in FIG. 2, a train 1 travels along a railway track 2.

The train 1 includes a short-distance LiDAR apparatus 3, a long-distance LiDAR apparatus 4, an inertial measurement unit (IMU) 5, an environment point cloud generation apparatus 6, an environment point cloud storage device 7, a front monitoring apparatus 8, a driving apparatus 9, a braking apparatus 10, and a plurality of wheels 11.

The driving apparatus 9 is formed of a motor and a motor driver. The driving apparatus 9 drives the wheels 11 according to a control signal from the front monitoring apparatus 8.

The braking apparatus 10 is formed of a brake and an oil hydraulic circuit. The braking apparatus 10 brakes the wheels 11 according to a control signal from the front monitoring apparatus 8.

The railway track 2 includes a track bed, a plurality of ties 2a aligned at a predetermined interval on the track bed, and two rails 2b supported by the plurality of ties 2a.

The short-distance LiDAR apparatus 3 and the long-distance LiDAR apparatus 4 are typically a LiDAR apparatus mounted on a first carriage of the train 1.

The LiDAR apparatus is one specific example of a sensing means for sensing an area ahead in a heading direction of the train 1 and generating a point cloud. The LiDAR apparatus according to the present example embodiment is a direct time of flight (ToF) type. In other words, the LiDAR apparatus generates a point cloud of an area ahead in the heading direction of the train 1 by emitting a laser beam forward in the heading direction of the train 1 and measuring a time required for receiving reflected light of the laser beam. However, instead of this, the LiDAR apparatus may be a frequency modulated continuous wave (FMCW) type that generates the point cloud described above, based on a frequency difference between the laser beam emitted forward in the heading direction of the train 1 and the reflected light of the laser beam. Further, the LiDAR apparatus may be an indirect ToF type that generates the point cloud described above, based on a phase difference between the laser beam emitted forward in the heading direction of the train 1 and the reflected light of the laser beam. The LiDAR apparatus outputs the generated point cloud to the environment point cloud generation apparatus 6.

Note that the sensing means is not limited to the LiDAR apparatus. As the sensing means, any apparatus can be adopted as long as it can perform sensing of an area ahead in the heading direction of the train 1. For example, the sensing means may be configured to generate a point cloud by a radio detection and ranging (radar) apparatus, an ultrasonic sensor, a stereo camera, or combinations thereof. Further, the sensing means may be configured to generate a point cloud by structure from motion (SfM) from a plurality of two-dimensional images acquired by capturing an area ahead in the heading direction of the train 1.

The short-distance LiDAR apparatus 3 is a LiDAR apparatus for short-distance detection having a detection distance from 20 meters to 200 meters. The short-distance LiDAR apparatus 3 outputs a point cloud generated during traveling of the train 1 as a short-distance point cloud to the environment point cloud generation apparatus 6.

The long-distance LiDAR apparatus 4 is a LiDAR apparatus for long-distance detection having a detection distance from 400 meters to 1000 meters. The long-distance LiDAR apparatus 4 outputs a point cloud generated during traveling of the train 1 as a long-distance point cloud to the environment point cloud generation apparatus 6.

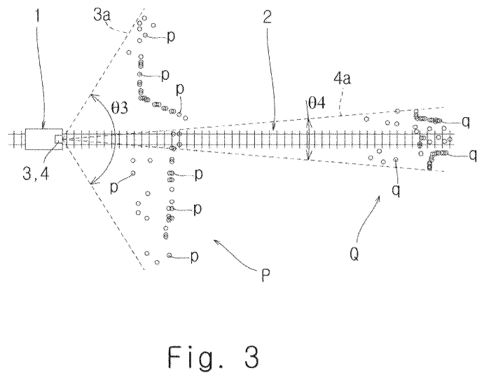

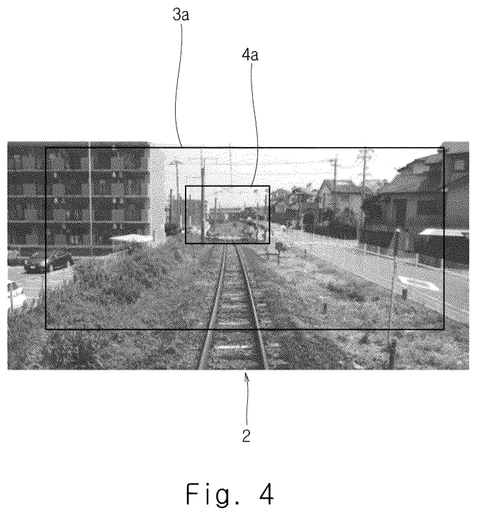

Herein, FIGS. 3 and 4 are referred. FIGS. 3 and 4 are explanatory diagrams of a distance measuring field of view of the LiDAR apparatus. FIG. 3 illustrates a plurality of distance measuring points constituting a point cloud in a plan view. FIG. 4 illustrates a point cloud in an area ahead in the heading direction of the train 1.

As illustrated in FIG. 3, a horizontal angle θ3 of a distance measuring field of view 3a of the short-distance LiDAR apparatus 3 is typically set to be 120 degrees. In other words, the short-distance LiDAR apparatus 3 is set in such a way as to measure a distance in the relatively wide distance measuring field of view 3a. In contrast, a horizontal angle θ4 of a distance measuring field of view 4a of the long-distance LiDAR apparatus 4 is typically set to be 5 degrees. In other words, the long-distance LiDAR apparatus 4 is configured to measure a distance in the relatively narrow distance measuring field of view 4a. Similarly, as illustrated in FIG. 4, a vertical angle of the distance measuring field of view 3a of the short-distance LiDAR apparatus 3 is set wider than a vertical angle of the distance measuring field of view 4a of the long-distance LiDAR apparatus 4.

A line of sight of the short-distance LiDAR apparatus 3 is an area ahead in the heading direction of the train 1, and is set to be parallel to a longitudinal direction of the railway track 2. Similarly, a line of sight of the long-distance LiDAR apparatus 4 is an area ahead in the heading direction of the train 1, and is set to be parallel to the longitudinal direction of the railway track 2. Therefore, as illustrated in FIGS. 3 and 4, the distance measuring field of view 3a of the short-distance LiDAR apparatus 3 and the distance measuring field of view 4a of the long-distance LiDAR apparatus 4 overlap each other. Further, the distance measuring field of view 4a of the long-distance LiDAR apparatus 4 is a field of view inside the distance measuring field of view 3a of the short-distance LiDAR apparatus 3.

Returning to FIG. 2, the IMU 5 detects three-axis acceleration and a three-axis angular speed of the train 1. The IMU 5 outputs a detection result to the environment point cloud generation apparatus 6.

The environment point cloud generation apparatus 6 reconstructs an environment point cloud in an area ahead in the heading direction of the train 1, based on a short-distance point cloud acquired from the short-distance LiDAR apparatus 3 and a long-distance point cloud acquired from the long-distance LiDAR apparatus 4. The environment point cloud generation apparatus 6 stores the reconstructed environment point cloud in the environment point cloud storage device 7. The front monitoring apparatus 8 detects an obstacle in the area ahead in the heading direction of the train 1, based on the environment point cloud stored in the environment point cloud storage device 7. Hereinafter, the environment point cloud generation apparatus 6, the environment point cloud storage device 7, and the front monitoring apparatus 8 will be described in detail.

The environment point cloud generation apparatus 6 includes a point cloud acquisition unit 20, a short-distance point cloud storage unit 21, a long-distance point cloud storage unit 22, a rough estimation unit 23, a self-position storage unit 24, a precision estimation unit 25, and an environment point cloud generation unit 26.

The point cloud acquisition unit 20 is one specific example of the point cloud acquisition means. The point cloud acquisition unit 20 acquires a short-distance point cloud from the short-distance LiDAR apparatus 3. While the point cloud acquisition unit 20 performs movement compensation on the acquired short-distance point cloud, based on a detection result of the IMU 5, the point cloud acquisition unit 20 stores the short-distance point cloud in the short-distance point cloud storage unit 21.

Similarly, the point cloud acquisition unit 20 acquires a long-distance point cloud from the long-distance LiDAR apparatus 4. While the point cloud acquisition unit 20 performs movement compensation on the acquired long-distance point cloud, based on a detection result of the IMU 5, the point cloud acquisition unit 20 stores the long-distance point cloud in the long-distance point cloud storage unit 22.

FIG. 3 illustrates a short-distance point cloud P and a long-distance point cloud Q. The short-distance point cloud P is formed of a plurality of distance measuring points p. The long-distance point cloud Q is formed of a plurality of distance measuring points q. Each of the distance measuring points p and each of the distance measuring points q are data formed of coordinate data in a LiDAR coordinate system fixed in the short-distance LiDAR apparatus 3, brightness data, distance measuring time data, and the like.

As illustrated in FIG. 3, the plurality of distance measuring points p constituting the short-distance point cloud P are distributed in a range from 20 meters to 200 meters from the train 1. In contrast, the plurality of distance measuring points q constituting the long-distance point cloud Q are distributed in a range from 400 meters to 600 meters from the train 1. As illustrated in FIG. 3, the long-distance point cloud Q is far away from the train 1, but has a sufficiently high point cloud density since the distance measuring field of view 4a of the long-distance LiDAR apparatus 4 is set to be relatively narrow.

Herein, the environment point cloud storage device 7 will be described. The environment point cloud storage device 7 is one specific example of the reference environment point cloud storage means. As illustrated in FIG. 2, the environment point cloud storage device 7 stores a reference environment point cloud 30 and a latest environment point cloud 31. The reference environment point cloud 30 is a point cloud in a surrounding environment of the railway track 2 on which the train 1 travels. The reference environment point cloud 30 is a point cloud generated at a certain point in time in the past. The reference environment point cloud 30 is typically generated with, as a trigger, traveling of a preceding train or an oncoming train. The latest environment point cloud 31 is a point cloud in a surrounding environment of the railway track 2 being generated in real time during traveling of the train 1.

Returning to the description of the environment point cloud generation apparatus 6, the rough estimation unit 23 is one specific example of the rough estimation means. The rough estimation unit 23 performs rough estimation on a self-position by registering the short-distance point cloud P stored in the short-distance point cloud storage unit 21 with respect to the reference environment point cloud 30. The rough estimation unit 23 stores a rough self-position subjected to the rough estimation in the self-position storage unit 24. The rough self-position is one specific example of a rough estimation result. Herein, the self-position means a position of a LiDAR coordinate system of the short-distance LiDAR apparatus 3 in a reference coordinate system of the reference environment point cloud 30. A position of the LiDAR coordinate system of the short-distance LiDAR apparatus 3 in the reference coordinate system of the reference environment point cloud 30 is typically formed of a three-axis translational component and a three-axis rotational component. As the registration technique described above, for example, iterative closest point (ICP) and normal distributions transform (NDT) can be used. As described above, since the distance measuring field of view 3a of the short-distance LiDAR apparatus 3 when generating the short-distance point cloud P is set to be a relatively wide field of view, it can be said that convergence of registration computation for registering the short-distance point cloud P with respect to the reference environment point cloud 30 is good. However, a rough self-position estimated by registering the short-distance point cloud P with respect to the reference environment point cloud 30 has slightly poor accuracy. Particularly, a slight angle error remains in a rotational component of a rough self-position. The angle error has an adverse effect that cannot be neglected when the latest environment point cloud 31 is reconstructed by overlapping a plurality of sets of long-distance point clouds as described below.

The precision estimation unit 25 is one specific example of the precision estimation means. The precision estimation unit 25 performs precision estimation on a self-position by registering the long-distance point cloud Q with respect to the reference environment point cloud 30 by using, as an initial condition, a rough self-position stored in the self-position storage unit 24. The precision estimation unit 25 stores a precision self-position subjected to the precision estimation in the self-position storage unit 24. In other words, the precision estimation unit 25 corrects a rough self-position by the precision estimation. The precision estimation unit 25 stores a precision self-position being a rough self-position after correction in the self-position storage unit 24.

As described above, the registration computation such as the ICP and the NDT has a property that affects convergence by whether an initial condition of the registration computation is good or bad. Particularly, when a point cloud density is naturally low as in the long-distance point cloud Q and the distance measuring field of view 4a is set to be a relatively narrow field of view, convergence is greatly affected by whether an initial condition is good or bad. In contrast, in the present example embodiment, since a rough self-position calculated by the rough estimation unit 23 is an initial condition, it can be said that an initial condition of the registration computation is sufficient, and convergence of the registration computation by the precision estimation unit 25 is accordingly sufficiently good.

The environment point cloud generation unit 26 generates the latest environment point cloud 31, based on the precision self-position stored in the self-position storage unit 24 and the long-distance point cloud Q. In other words, the environment point cloud generation unit 26 generates the latest environment point cloud 31 by overlapping the plurality of sets of the long-distance point clouds Q in the reference coordinate system while shifting the plurality of sets, based on the precision self-position associated with the long-distance point cloud Q.

In this way, estimating a self-position by registering the long-distance point cloud Q with respect to the reference environment point cloud 30, and generating the latest environment point cloud 31 by overlapping the plurality of sets of the long-distance point clouds Q are referred to as the SLAM as described above.

The front monitoring apparatus 8 includes an obstacle determination unit 40 and a vehicle control unit 41.

The obstacle determination unit 40 determines presence or absence of an obstacle in an area ahead in the heading direction of the train 1, based on the latest environment point cloud 31 stored in the environment point cloud storage device 7. Specifically, the obstacle determination unit 40 may extract a point cloud being a difference between the reference environment point cloud 30 and the latest environment point cloud 31, and determine presence or absence of an obstacle, based on the extracted point cloud. Instead of this, the obstacle determination unit 40 may determine Swept Volume in which the train 1 passes, based on the latest environment point cloud 31, and determine presence or absence of an obstacle in an area ahead in the heading direction of the train 1 by performing object detection using PointNet in the Swept Volume.

When the obstacle determination unit 40 detects an obstacle, the vehicle control unit 41 outputs a deceleration signal to the braking apparatus 10. In this way, the vehicle control unit 41 stops the train 1 before the train 1 collides with an obstacle.

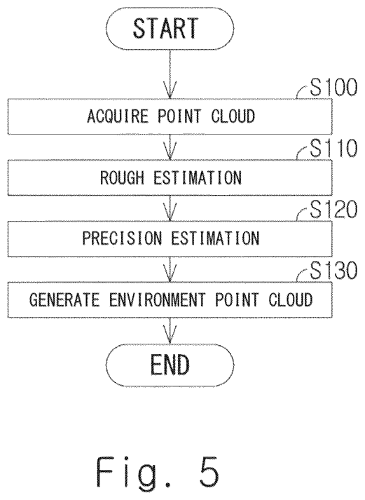

Next, a control flow of the environment point cloud generation apparatus 6 will be described. FIG. 5 illustrates the control flow of the environment point cloud generation apparatus 6. Herein, it is assumed that the SLAM is performed while the train 1 travels along the railway track 2.

First, the point cloud acquisition unit 20 acquires the short-distance point cloud P and the long-distance point cloud Q (S100). Next, the rough estimation unit 23 performs rough estimation on a self-position by registering the short-distance point cloud P with respect to the reference environment point cloud 30 (S110). Next, the precision estimation unit 25 performs precision estimation on the self-position by registering the long-distance point cloud Q with respect to the reference environment point cloud 30 by using a rough self-position as an initial condition (S120). Next, the environment point cloud generation unit 26 generates the latest environment point cloud 31, based on the long-distance point cloud Q and a precision self-position (S130).

The first example embodiment of the present disclosure is described above, and the first example embodiment described above has the following characteristic.

The environment point cloud generation apparatus 6 is one specific example of the self-position estimation system and a self-position estimation apparatus. As illustrated in FIG. 2, the environment point cloud generation apparatus 6 includes the environment point cloud storage device 7 (reference environment point cloud storage means), the point cloud acquisition unit 20 (point cloud acquisition means), the rough estimation unit 23 (rough estimation means), and the precision estimation unit 25 (precision estimation means). The environment point cloud storage device 7 stores the reference environment point cloud 30 for self-position estimation. The point cloud acquisition unit 20 acquires the short-distance point cloud P in a wide field of view, and the long-distance point cloud Q farther away than the short-distance point cloud and in a narrow field of view. The rough estimation unit 23 performs rough estimation on a self-position by registering the short-distance point cloud P with respect to the reference environment point cloud 30. The precision estimation unit 25 performs precision estimation on the self-position by registering the long-distance point cloud Q with respect to the reference environment point cloud 30 by using, as an initial condition, a rough self-position as a rough estimation result by the rough estimation unit 23. With the configuration described above, a highly accurate self-position estimation technique using the long-distance point cloud Q is achieved.

The wide field of view is one specific example of a first field of view. The narrow field of view is one specific example of a second field of view narrower than the first field of view.

The short-distance point cloud is one specific example of a first point cloud. The long-distance point cloud is one specific example of a second point cloud farther away than the first point cloud.

As illustrated in FIG. 3, the short-distance point cloud P and the long-distance point cloud Q are both a point cloud acquired by measuring a distance of an area ahead in a heading direction of a preceding vehicle (vehicle) of the train 1.

As illustrated in FIGS. 3 and 4, the distance measuring field of view 3a of the short-distance point cloud P and the distance measuring field of view 4a of the long-distance point cloud Q overlap each other.

### Second Example Embodiment

Next, a second example embodiment will be described. Hereinafter, a difference between the present example embodiment and the first example embodiment described above will be mainly described, and repeated description will be omitted.

FIG. 3 is referred again. As illustrated in FIG. 3, the long-distance point cloud Q naturally has a low point cloud density, and thus has a property in which an isolated point is more likely to occur. Then, such an isolated point may act as noise in precision estimation of a self-position by the precision estimation unit 25, and become a cause of a reduction in estimation accuracy of the precision estimation. Thus, in the present example embodiment, a distance measuring point that does not contribute to the precision estimation of a self-position by a precision estimation unit 25 is removed from a long-distance point cloud Q. It is specifically described as follows.

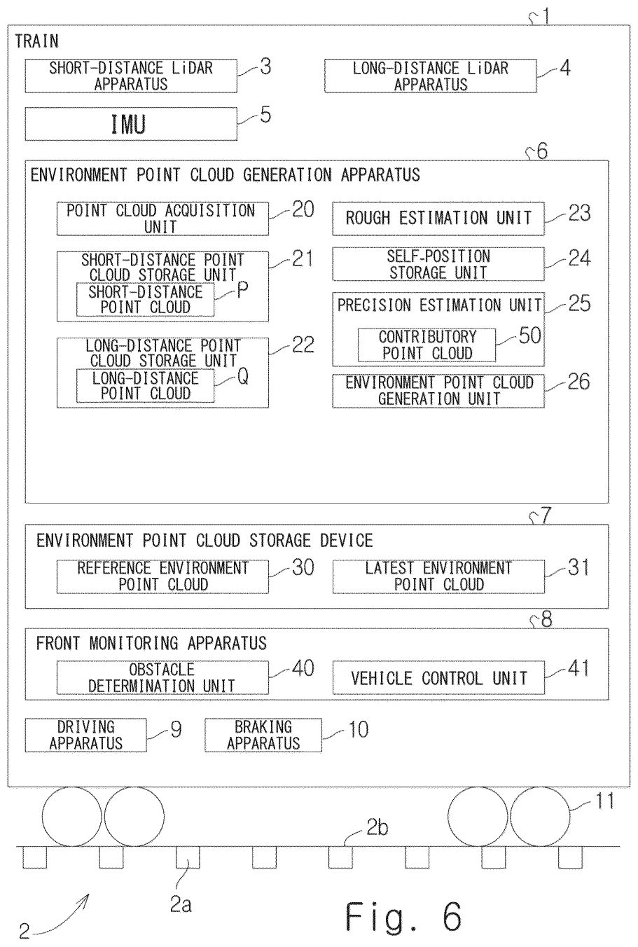

FIG. 6 is a block diagram of a train 1. As illustrated in FIG. 6, the precision estimation unit 25 extracts a contributory point cloud 50 that contributes to precision estimation from the long-distance point cloud Q. Then, the precision estimation unit 25 performs the precision estimation on a self-position by registering the contributory point cloud 50 with respect to a reference environment point cloud 30. In this way, estimation accuracy of the precision estimation can be improved. Furthermore, a calculation amount of registration computation is simply reduced by registering, with respect to the reference environment point cloud 30 instead of the long-distance point cloud Q, the contributory point cloud 50 having a smaller number of distance measuring points than that of the long-distance point cloud Q.

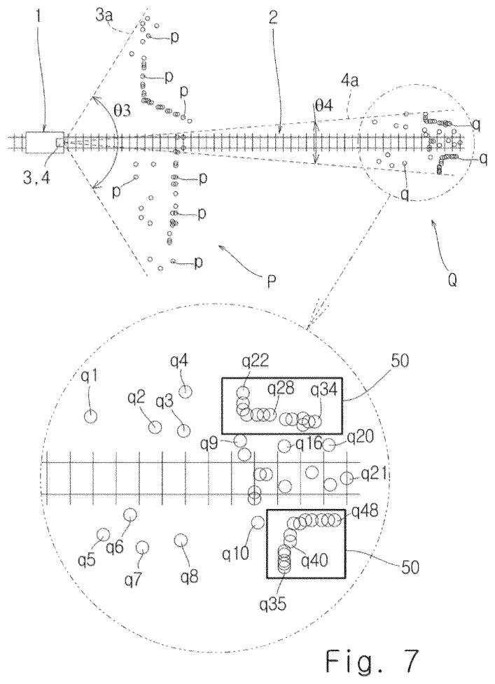

In the present example embodiment, the contributory point cloud 50 is a “point cloud having continuity having equal to or more than a predetermined distance”. Herein, FIG. 7 is referred. FIG. 7 is a plan distribution map of distance measuring points. As illustrated in FIG. 7, a distance measuring point q1 to a distance measuring point q21 are scattered in a disorganized manner, but a distance measuring point q22 to a distance measuring point q34 are aligned in a connected manner to some extent. A distance measuring point q35 to a distance measuring point q48 are also aligned in a connected manner to some extent.

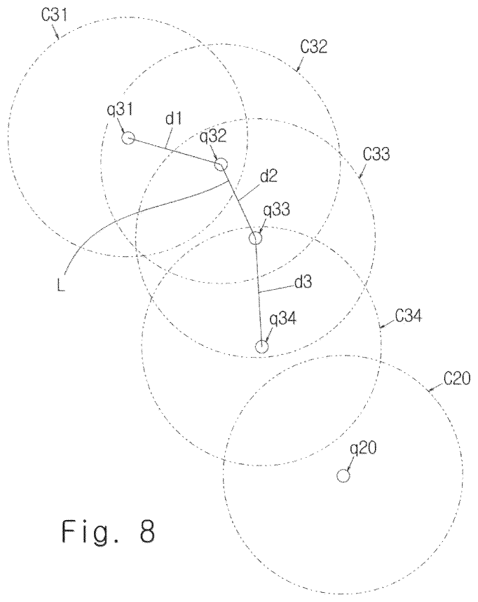

Herein, a “point cloud having continuity” will be described with reference to FIG. 8. FIG. 8 is an explanatory diagram related to continuity. FIG. 8 illustrates the distance measuring point q31, the distance measuring point q32, the distance measuring point q33, the distance measuring point q34, and the distance measuring point q20. When a circle C31 having a predetermined diameter with the distance measuring point q31 as the center is drawn, the distance measuring point q32 is located in the circle C31. Therefore, it can be said that the distance measuring point q31 and the distance measuring point q32 are close to each other and have continuity. Similarly, when a circle C32 having a predetermined diameter with the distance measuring point q32 as the center is drawn, the distance measuring point q33 is located in the circle C32. Therefore, it can be said that the distance measuring point q32 and the distance measuring point q33 are close to each other and have continuity. Similarly, when a circle C33 having a predetermined diameter with the distance measuring point q33 as the center is drawn, the distance measuring point q34 is located in the circle C33. Therefore, it can be said that the distance measuring point q33 and the distance measuring point q34 are close to each other and have continuity. In contrast, when a circle C34 having a predetermined diameter with the distance measuring point q34 as the center is drawn, the distance measuring point q20 is not located in the circle C34. Therefore, it can be said that the distance measuring point q34 and the distance measuring point q20 are not close to each other and do not have continuity. As a result, the distance measuring point q31, the distance measuring point q32, the distance measuring point q33, and the distance measuring point q34 correspond to the “point cloud having continuity”.

Next, the “point cloud having continuity having equal to or more than a predetermined distance” will be continuously described with reference to FIG. 8. As described above, the distance measuring point q31, the distance measuring point q32, the distance measuring point q33, and the distance measuring point q34 correspond to the point cloud having continuity. One zigzag line L that couples the distance measuring point q31, the distance measuring point q32, the distance measuring point q33, and the distance measuring point q34 to each other is drawn. Specifically, a connected order of the distance measuring point q31, the distance measuring point q32, the distance measuring point q33, and the distance measuring point q34 is determined in such a way that a length of the zigzag line L is the shortest. Then, when the length of the zigzag line L is equal to or more than a predetermined distance, the distance measuring point q31, the distance measuring point q32, the distance measuring point q33, and the distance measuring point q34 are assumed to correspond to the “point cloud having continuity having equal to or more than a predetermined distance”. Herein, the “length of the zigzag line L” corresponds to a total sum of a length of a line segment d1 that couples the distance measuring point q31 and the distance measuring point q32, a length of a line segment d2 that couples the distance measuring point q32 and the distance measuring point q33, and a length of a line segment d3 that couples the distance measuring point q33 and the distance measuring point q34. Note that, in FIG. 8, vertical elevation values (Z values) of the distance measuring point q31, the distance measuring point q32, the distance measuring point q33, and the distance measuring point q34 are not considered, and the “point cloud having continuity having equal to or more than a predetermined distance” is defined on an assumption that all of the distance measuring points are present on the same horizontal plane. However, it is actually rare that all of the distance measuring point q31, the distance measuring point q32, the distance measuring point q33, and the distance measuring point q34 are present on the same horizontal plane, and the vertical elevation values (Z values) of the distance measuring point q31, the distance measuring point q32, the distance measuring point q33, and the distance measuring point q34 are values different from one another. Therefore, whether the “point cloud having continuity” actually corresponds to the “point cloud having continuity having equal to or more than a predetermined distance” may be required to be determined after the zigzag line L described above is defined three-dimensionally.

Note that a method for extracting the contributory point cloud 50 from the long-distance point cloud Q is not limited to the method described above. For example, a point cloud gathered at a point cloud density to some extent in the long-distance point cloud Q may be extracted as the contributory point cloud 50. Further, a determination reference of continuity may be adjusted by appropriately increasing or reducing a diameter of the circle C illustrated in FIG. 8. Further, the contributory point cloud 50 may be extracted from the long-distance point cloud Q by using a segmentation algorithm and a RANSAC algorithm.

The second example embodiment of the present disclosure is described above, and the example embodiment described above has the following characteristic.

In other words, the precision estimation unit 25 extracts the contributory point cloud 50 that contributes to precision estimation from the long-distance point cloud Q. The precision estimation unit 25 performs the precision estimation on a self-position by registering the extracted contributory point cloud 50 with respect to the reference environment point cloud 30. According to the configuration described above, estimation accuracy of the precision estimation can be further improved, and a calculation amount of the registration computation can be reduced.

Further, the contributory point cloud 50 is a point cloud having continuity having equal to or more than a predetermined distance. According to the configuration described above, there is a high possibility that the contributory point cloud 50 is a point cloud, such as a wall surface of a building, being clearly different from a noise point cloud and being associated with a structure more likely to contribute to position estimation. Therefore, estimation accuracy of the precision estimation by the precision estimation unit 25 can be further improved.

Note that a building includes an architectural structure built for a person to live and gather, such as an office building and an apartment building, and a structure built for being useful to convenience of a life, such as, for example, a bridge, a tunnel, a dam, and a steel tower.

### Third Example Embodiment

Next, a third example embodiment will be described. Hereinafter, a difference between the present example embodiment and the second example embodiment described above will be mainly described, and repeated description will be omitted.

In the second example embodiment described above, the contributory point cloud 50 is assumed to be a point cloud having continuity having equal to or more than a predetermined distance.

In contrast, in the present example embodiment, a precision estimation unit 25 extracts, as a contributory point cloud 50, a point cloud associated with a building from a long-distance point cloud Q. The reason is that a point cloud associated with a building is connected in such a way as to have a corner in a plan view, and greatly contributes to precision estimation by the precision estimation unit 25.

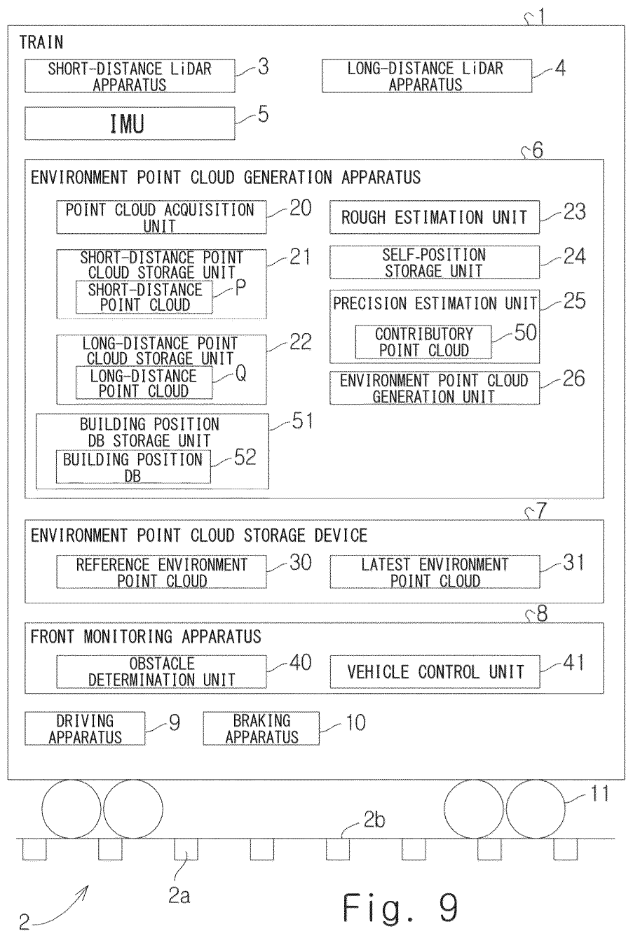

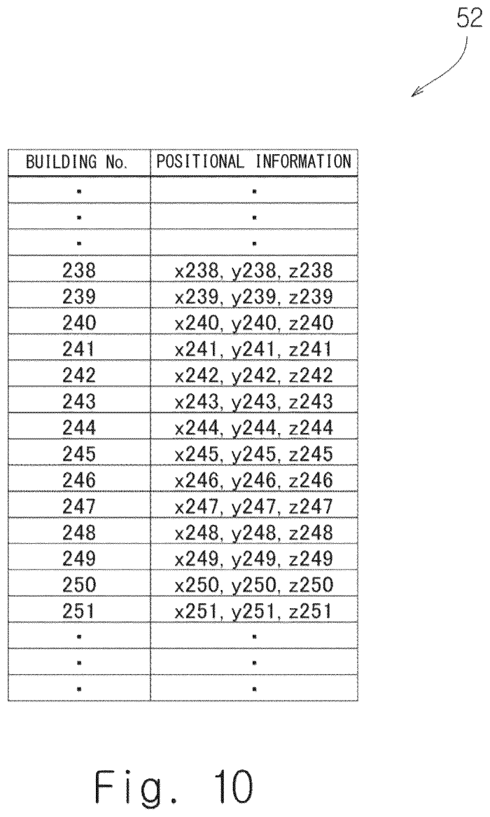

FIG. 9 is a block diagram of a train 1. As illustrated in FIG. 9, in the present example embodiment, an environment point cloud generation apparatus 6 further includes a building position database storage unit 51 that stores a building position database 52. The building position database storage unit 51 is one specific example of a building position database storage means. FIG. 10 illustrates a data structure of the building position database 52. As illustrated in FIG. 10, the building position database 52 is a database related to positional information about a plurality of buildings suitable for registration computation. The positional information about each building is expressed in a reference coordinate system. According to the building position database 52, for example, positional information about a building No. 245 is (x245, y245, z245).

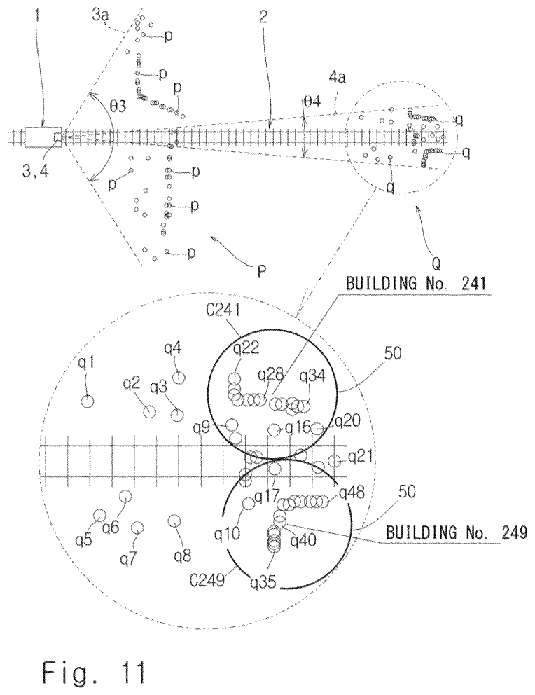

Then, the precision estimation unit 25 extracts, as the contributory point cloud 50, a point cloud associated with at least one building from the long-distance point cloud Q by referring to the building position database 52. Specifically, the precision estimation unit 25 calculates positions of a plurality of buildings in a LiDAR coordinate system, based on positions of a plurality of buildings recorded in the building position database 52 and a rough self-position. Herein, as illustrated in FIG. 11, for example, a building No. 241 and a building No. 249 are assumed to be present near the long-distance point cloud Q. In this case, the precision estimation unit 25 draws a circle C241 having a predetermined diameter with a position of the building No. 241 as the center, and extracts, as the contributory point cloud 50, a plurality of distance measuring points present in the circle C241 from the long-distance point cloud Q. In the example in FIG. 11, the plurality of distance measuring points present in the circle C241 are a distance measuring point q9, a distance measuring point q16, a distance measuring point q20, a distance measuring point q22 to a distance measuring point q34, and the like. Similarly, in this case, the precision estimation unit 25 draws a circle C249 having a predetermined diameter with a position of the building No. 249 as the center, and extracts, as the contributory point cloud 50, a plurality of distance measuring points present in the circle C249 from the long-distance point cloud Q. In the example in FIG. 11, the plurality of distance measuring points present in the circle C249 are a distance measuring point q10, a distance measuring point q17, a distance measuring point q35 to a distance measuring point q48, and the like.

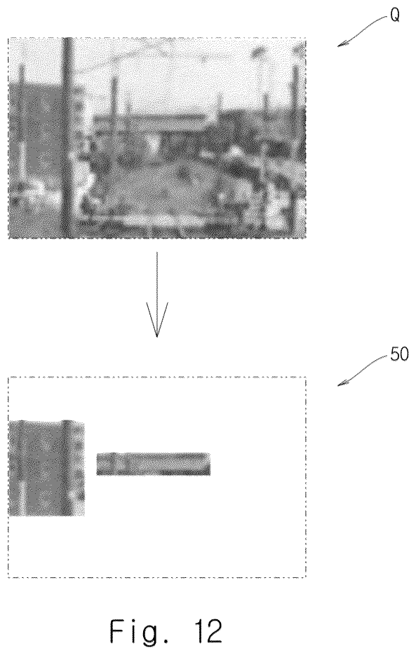

FIG. 12 illustrates the long-distance point cloud Q and the contributory point cloud 50 extracted from the long-distance point cloud Q. The long-distance point cloud Q is associated with an upper region of two regions surrounded by a chain double-dashed line in FIG. 12. The contributory point cloud 50 is associated with a lower region of the two regions surrounded by the chain double-dashed line in FIG. 12. As illustrated in FIG. 12, the contributory point cloud 50 includes a smaller number of a plurality of distance measuring points than a plurality of distance measuring points constituting the long-distance point cloud Q.

The third example embodiment of the present disclosure is described above, and the example embodiment described above has the following characteristic.

In other words, the environment point cloud generation apparatus 6 further includes the building position database storage unit 51 that stores the building position database 52 indicating positional information about a plurality of buildings contributing to precision estimation. The precision estimation unit 25 extracts, as the contributory point cloud 50, point clouds associated with a plurality of buildings from the long-distance point cloud Q by referring to the building position database 52. In this way, estimation accuracy of the precision estimation can be improved. Furthermore, a calculation amount of registration computation may be simply reduced by registering, with respect to the reference environment point cloud 30 instead of the long-distance point cloud Q, the contributory point cloud 50 having a smaller number of distance measuring points than that of the long-distance point cloud Q. Further, as compared to the second example embodiment described above, complicated computation required to extract the contributory point cloud 50 from the long-distance point cloud Q is not needed, and thus real-time property of information processing of the environment point cloud generation apparatus 6 improves.

### Fourth Example Embodiment

Next, a fourth example embodiment of the present disclosure will be described. Hereinafter, a difference between the present example embodiment and the third example embodiment described above will be mainly described, and repeated description will be omitted.

In the third example embodiment described above, the precision estimation unit 25 performs the precision estimation on a self-position by registering the contributory point cloud 50 with respect to the reference environment point cloud 30.

In contrast, in the present example embodiment, a calculation amount of registration computation when a contributory point cloud 50 is registered with respect to a reference environment point cloud 30 is further reduced by reducing the number of a plurality of distance measuring points constituting the reference environment point cloud 30. In other words, in the present example embodiment, a point cloud associated with a building is extracted as a partial reference environment point cloud from the reference environment point cloud 30 as in a manner in which the precision estimation unit 25 extracts, as the contributory point cloud 50, a point cloud associated with a building from the long-distance point cloud Q in the third example embodiment described above. Then, a precision estimation unit 25 registers the contributory point cloud 50 with respect to the partial reference environment point cloud instead of registering a long-distance point cloud Q with respect to the reference environment point cloud 30. It is specifically described as follows.

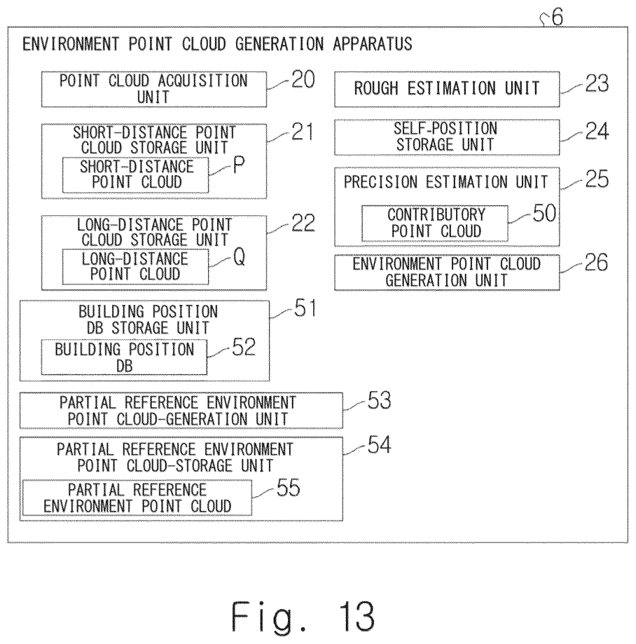

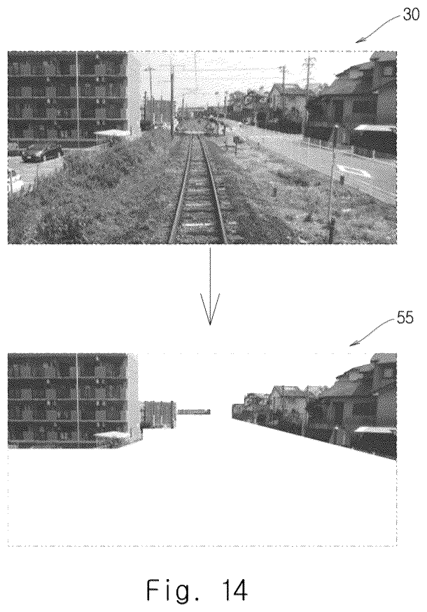

FIG. 13 is a block diagram of an environment point cloud generation apparatus 6. As illustrated in FIG. 13, the environment point cloud generation apparatus 6 further includes a partial reference environment point cloud-generation unit 53 and a partial reference environment point cloud-storage unit 54. The partial reference environment point cloud-generation unit 53 generates a partial reference environment point cloud 55. Specifically, the partial reference environment point cloud-generation unit 53 generates the partial reference environment point cloud 55 by deleting a distance measuring point other than distance measuring points associated with a plurality of buildings from the long-distance point cloud Q. At this time, the partial reference environment point cloud-generation unit 53 may refer to a building position database 52 stored in a building position database storage unit 51. The partial reference environment point cloud-generation unit 53 can determine, for each distance measuring point, whether the distance measuring point is a distance measuring point associated with any of a plurality of buildings by referring to the building position database 52. The partial reference environment point cloud-generation unit 53 stores the generated partial reference environment point cloud 55 in the partial reference environment point cloud-storage unit 54. The partial reference environment point cloud-storage unit 54 is one specific example of a partial reference environment point cloud-storage means for storing the partial reference environment point cloud 55. FIG. 14 illustrates the reference environment point cloud 30 and the partial reference environment point cloud 55. The reference environment point cloud 30 is associated with an upper region of two regions surrounded by a chain double-dashed line in FIG. 14. The partial reference environment point cloud 55 is associated with a lower region of the two regions surrounded by the chain double-dashed line in FIG. 14. As illustrated in FIG. 14, the partial reference environment point cloud 55 is a part of the reference environment point cloud 30. The partial reference environment point cloud 55 is formed of a point cloud related to a building in the reference environment point cloud 30.

Then, the precision estimation unit 25 performs precision estimation on a self-position by registering the contributory point cloud 50 with respect to the partial reference environment point cloud 55.

The fourth example embodiment is described above, and the fourth example embodiment described above has the following characteristic.

The environment point cloud generation apparatus 6 further includes the partial reference environment point cloud-storage unit 54 that stores the partial reference environment point cloud 55 acquired by deleting a distance measuring point other than distance measuring points associated with a plurality of buildings from the reference environment point cloud 30. The precision estimation unit 25 performs precision estimation on a self-position by registering the contributory point cloud 50 with respect to the partial reference environment point cloud 55. According to the configuration described above, as compared to the third example embodiment described above, a data amount of a point cloud being a target of registration with respect to the contributory point cloud 50 is reduced, and thus real-time property of information processing of the environment point cloud generation apparatus 6 further improves.

Next, a hardware configuration of the environment point cloud generation apparatus 6 will be described. In the environment point cloud generation apparatus 6, the point cloud acquisition unit 20, the rough estimation unit 23, the precision estimation unit 25, the environment point cloud generation unit 26, and the partial reference environment point cloud-generation unit 53 are achieved by a processing circuit. The short-distance point cloud storage unit 21, the long-distance point cloud storage unit 22, the self-position storage unit 24, the building position database storage unit 51, and the partial reference environment point cloud-storage unit 54 are achieved by a storage circuit. The processing circuit may be a processor that executes a program stored in a memory and the memory, or may be dedicated hardware.

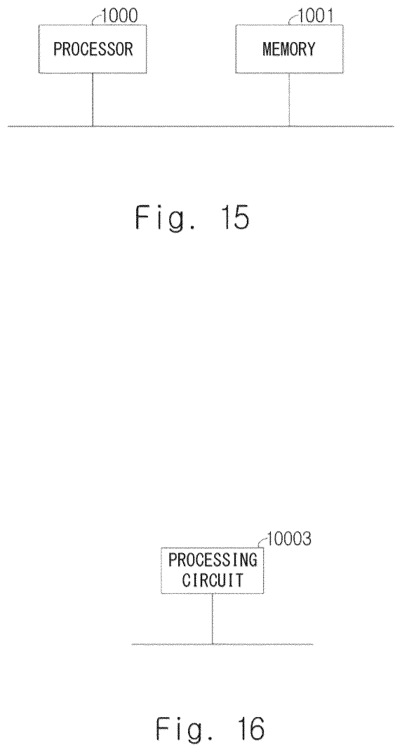

FIG. 15 is a diagram illustrating an example of a case where the processing circuit included in the environment point cloud generation apparatus 6 is formed of a processor and a memory. When the processing circuit is formed of a processor 1000 and a memory 1001, each function of the processing circuit of the environment point cloud generation apparatus 6 is implemented by software, firmware, or a combination of software and firmware. The software or the firmware is written as a program and stored in the memory 1001. In the processing circuit, each function is implemented by the processor 1000 reading and executing a program stored in the memory 1001. In other words, the processing circuit includes the memory 1001 for storing a program in which processing of the environment point cloud generation apparatus 6 is to be executed. These programs can also be said to cause a computer to execute procedures and methods for the environment point cloud generation apparatus 6.

Herein, the processor 1000 may be a central processing unit (CPU), a processing apparatus, an arithmetic apparatus, a microprocessor, a microcomputer, a digital signal processor (DSP), or the like. Further, the memory 1001 includes, for example, a non-volatile or volatile semiconductor memory such as a random access memory (RAM), a read only memory (ROM), a flash memory, an erasable programmable ROM (EPROM), and an electrically EPROM (EEPROM) (registered trademark), a magnetic disk, a flexible disk, an optical disk, a compact disk, a mini disk, a digital versatile disc (DVD), or the like.

FIG. 16 is a diagram illustrating an example of a case where the processing circuit included in the environment point cloud generation apparatus 6 is formed of dedicated hardware. When the processing circuit is formed of dedicated hardware, a processing circuit 1002 illustrated in FIG. 16 is, for example, a single circuit, a composite circuit, a programmed processor, a parallel programmed processor, an application specific integrated circuit (ASIC), a field programmable gate array (FPGA), or a combination of thereof. Each function of the environment point cloud generation apparatus 6 may be implemented by the processing circuit 1002 separately for each function, or each function may be collectively implemented by the processing circuit 1002.

Note that some of the functions of the environment point cloud generation apparatus 6 may be implemented by dedicated hardware, and some of the functions may be implemented by software or firmware. In this way, the processing circuit can implement the functions described above by dedicated hardware, software, firmware, or a combination of thereof.

Although the present disclosure has been described above with reference to the example embodiments, the present disclosure is not limited to the above-described example embodiments. Various modifications that can be understood by those skilled in the art can be made to the configuration and the details of the present disclosure within the scope of the present disclosure.

In other words, as illustrated in FIG. 2, the train 1 includes the short-distance LiDAR apparatus 3 and the long-distance LiDAR apparatus 4. However, instead of this, one LiDAR apparatus may change a distance measuring field of view in a time-division manner. In this way, the one LiDAR apparatus can output the short-distance point cloud P and the long-distance point cloud Q to the environment point cloud generation apparatus 6.

Further, an application example of the above-described technique for improving accuracy of the SLAM by using the short-distance point cloud P when the SLAM is executed by using the long-distance point cloud Q is not limited to the train 1. The application example includes various moving bodies including an automobile, an aircraft, and a ship.

As illustrated in FIG. 3, a line of sight of the short-distance LiDAR apparatus 3 is assumed to be along the longitudinal direction of the railway track 2. However, instead of this, a line of sight of the short-distance LiDAR apparatus 3 may be oblique or perpendicular to the longitudinal direction of the railway track 2.

As illustrated in FIG. 3, a line of sight of the long-distance LiDAR apparatus 4 is assumed to be along the longitudinal direction of the railway track 2. However, when the railway track 2 is curved, a line of sight of the long-distance LiDAR apparatus 4 may be appropriately changed.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the exemplary embodiments disclosed above can be described as, but not limited to, the following supplementary notes.

### (Supplementary Note 1)

A self-position estimation system including:
a reference environment point cloud storage means for storing a reference environment point cloud for self-position estimation;
a point cloud acquisition means for acquiring a short-distance point cloud in a wide field of view, and a long-distance point cloud farther away than the short-distance point cloud and in a narrow field of view;
a rough estimation means for performing rough estimation on a self-position by registering the short-distance point cloud with respect to the reference environment point cloud; and
a precision estimation means for performing precision estimation on the self-position by registering the long-distance point cloud with respect to the reference environment point cloud by using, as an initial condition, a rough estimation result by the rough estimation means.

### (Supplementary Note 2)

The self-position estimation system according to supplementary note 1, wherein the precision estimation means extracts a contributory point cloud that contributes to precision estimation from the long-distance point cloud, and performs precision estimation on the self-position by registering the extracted contributory point cloud with respect to the reference environment point cloud.

### (Supplementary Note 3)

The self-position estimation system according to supplementary note 2, wherein the contributory point cloud is a point cloud having continuity with equal to or more than a predetermined distance.

### (Supplementary Note 4)

The self-position estimation system according to supplementary note 2, further including a building position database storage means for storing a building position database indicating positional information about a plurality of buildings that contribute to the precision estimation,
wherein the precision estimation means extracts, as the contributory point cloud, a point cloud associated with at least any one building of the plurality of buildings from the long-distance point cloud by referring to the building position database.

### (Supplementary Note 5)

The self-position estimation system according to supplementary note 4, further including a partial reference environment point cloud-storage means for storing a partial reference environment point cloud acquired by deleting a distance measuring point other than distance measuring points associated with the plurality of buildings from the reference environment point cloud,
wherein the precision estimation means performs precision estimation on the self-position by registering the contributory point cloud with respect to the partial reference environment point cloud.

### (Supplementary Note 6)

The self-position estimation system according to supplementary note 1, wherein the short-distance point cloud and the long-distance point cloud are both a point cloud acquired by measuring a distance in an area ahead in a heading direction of a vehicle.

### (Supplementary Note 7)

The self-position estimation system according to supplementary note 1, wherein a field of view of the short-distance point cloud and a field of view of the long-distance point cloud overlap each other.

### (Supplementary Note 8)

A self-position estimation apparatus including:
a reference environment point cloud storage means for storing a reference environment point cloud for self-position estimation;
a point cloud acquisition means for acquiring a short-distance point cloud in a wide field of view, and a long-distance point cloud farther away than the short-distance point cloud and in a narrow field of view;
a rough estimation means for performing rough estimation on a self-position by registering the short-distance point cloud with respect to the reference environment point cloud; and
a precision estimation means for performing precision estimation on the self-position by registering the long-distance point cloud with respect to the reference environment point cloud by using, as an initial condition, a rough estimation result by the rough estimation means.

### (Supplementary Note 9)

A self-position estimation method including:
storing a reference environment point cloud for self-position estimation;
acquiring a short-distance point cloud in a wide field of view, and a long-distance point cloud farther away than the short-distance point cloud and in a narrow field of view;
performing rough estimation on a self-position by registering the short-distance point cloud with respect to the reference environment point cloud; and
performing precision estimation on the self-position by registering the long-distance point cloud with respect to the reference environment point cloud by using, as an initial condition, a rough estimation result of the rough estimation.

### (Supplementary Note 10)

A program causing a computer to execute the self-position estimation method according to supplementary note 9.

A part or the whole of the elements (for example, the configuration and the functions) described in supplementary note 2 to supplementary note 7 subordinate to supplementary note 1 may also be subordinate to supplementary note 8, supplementary note 9, and supplementary note 10 in a similar subordinate relationship among supplementary note 2 to supplementary note 7. A part or the whole of the elements described in any supplementary note may be applied to various types of hardware, software, recording means for recording software, systems, and methods.

According to the present disclosure, a highly accurate self-position estimation technique using a long-distance point cloud is achieved.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The first to fourth embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A self-position estimation system comprising
at least one memory storing computer-executable instructions; and
at least one processor configured to access the at least one memory and execute the computer-executable instructions to:
store a reference environment point cloud for self-position estimation;
acquire a short-distance point cloud in a wide field of view, and a long-distance point cloud farther away than the short-distance point cloud and in a narrow field of view;
perform rough estimation on a self-position by registering the short-distance point cloud with respect to the reference environment point cloud; and
perform precision estimation on the self-position by registering the long-distance point cloud with respect to the reference environment point cloud by using, as an initial condition, a rough estimation result of the rough estimation.

2. The self-position estimation system according to claim 1, wherein the at least one processor is further configured to execute the instructions to:
extract a contributory point cloud that contributes to precision estimation from the long-distance point cloud; and
perform precision estimation on the self-position by registering the extracted contributory point cloud with respect to the reference environment point cloud.

3. The self-position estimation system according to claim 2, wherein the contributory point cloud is a point cloud having continuity with equal to or more than a predetermined distance.

4. The self-position estimation system according to claim 2, wherein the at least one processor is further configured to execute the instructions to:
store a building position database indicating positional information about a plurality of buildings that contribute to the precision estimation; and
extract, as the contributory point cloud, a point cloud associated with at least any one building of the plurality of buildings from the long-distance point cloud by referring to the building position database.

5. The self-position estimation system according to claim 4, wherein the at least one processor is further configured to execute the instructions to:
store a partial reference environment point cloud acquired by deleting a distance measuring point other than distance measuring points associated with the plurality of buildings from the reference environment point cloud; and
perform precision estimation on the self-position by registering the contributory point cloud with respect to the partial reference environment point cloud.

6. The self-position estimation system according to claim 1, wherein the short-distance point cloud and the long-distance point cloud are both a point cloud acquired by measuring a distance in an area ahead in a heading direction of a vehicle.

7. The self-position estimation system according to claim 1, wherein a field of view of the short-distance point cloud and a field of view of the long-distance point cloud overlap each other.

8. A self-position estimation apparatus comprising
at least one memory storing computer-executable instructions; and
at least one processor configured to access the at least one memory and execute the computer-executable instructions to:
store a reference environment point cloud for self-position estimation;
acquire a short-distance point cloud in a wide field of view, and a long-distance point cloud farther away than the short-distance point cloud and in a narrow field of view;
perform rough estimation on a self-position by registering the short-distance point cloud with respect to the reference environment point cloud; and
perform precision estimation on the self-position by registering the long-distance point cloud with respect to the reference environment point cloud by using, as an initial condition, a rough estimation result of the rough estimation.

9. A computer-implemented self-position estimation method being performed by at least one processor executing stored instructions to perform steps comprising:
storing a reference environment point cloud for self-position estimation;
acquiring a short-distance point cloud in a wide field of view, and a long-distance point cloud farther away than the short-distance point cloud and in a narrow field of view;
performing rough estimation on a self-position by registering the short-distance point cloud with respect to the reference environment point cloud; and
performing precision estimation on the self-position by registering the long-distance point cloud with respect to the reference environment point cloud by using, as an initial condition, a rough estimation result of the rough estimation.

10. A non-transitory computer-readable storage medium storing a program for causing a computer to execute the computer-implemented self-position estimation method according to claim 9.
